(19) United States
(12) Patent Application Publication
(10) Pub. No.: US 2002/0088318 A1
(43) Pub. Date: Jul. 11, 2002

(54) Structure of a small lathe and miller assembly

(76) Inventor: Ching Chih Wang, Taipei (TW)

Correspondence Address: Ching Chih Wang, PO Box 82-144, Taipei, TW

(21) Appl. No.: 09/756,917

(22) Filed: Jan. 10, 2001

(51) Int. Cl. B23B 9/00; B23B 11/00

(52) U.S. Cl. 82/121; 82/131

(57) ABSTRACT

An improved structure of a small lathe and miller assembly includes a lathe, a guide track means, and a miller. The rear side of the lathe bed of the lathe is secured to the guide track means for connection with the miller. The arrangement of a scale on the outer periphery of a rotary chuck, an indexing element at one side of a chuck seat allows setting of the angle of the workpiece held by the rotary chuck, and a curved protecting cover with a scale fastened above the rotary chuck on the chuck seat. A stop plate is secured to a rear side of the chuck seat by a frame plate and a lock handle. A moving block is fixedly connected to a bottom side of a column of the miller. The moving block is provided with dovetail slide grooves for mating with corresponding dovetail tenons of the guide track means. The moving block is screwably secured to guide blocks in the guide track means. Turning of a hand wheel may cause the moving block to displace on the guide track means to adjust the distance of the miller relative to the rotary chuck of the lathe, so that the workpiece held by the rotary chuck may be further processed by the miller after being processed by the lathe.

### FIELD OF THE INVENTION

This invention is related to an improved structure of a small lathe and miller assembly.

### DESCRIPTION OF THE PRIOR ART

FIG. 1 shows the structure of a conventional small lathe and miller assembly. It essentially comprises a lathe 10, a connecting block 20, and a miller 30. The rear side of a lathe bed 11 of the lathe 10 is locked to the connecting block by bolts 21. The connecting block 20 receives a column 31 of the miller 30, and the connection is secured by a packing ring 32 and a bolt 33. With reference to FIGS. 1 and 2, a cutter holder 13 is mounted on a saddle seat 12 so that the lathe 10 may lathe a workpiece held by a rotary chuck 12. Referring to FIGS. 2 and 3, when the cutter holder 13 on the saddle seat 12 is replaced by a workbench 15, the miller 30 may be used to mill the workpiece on the workbench 15. Since the miller 30 is locked to the lathe bed 11 of the lathe 10, it cannot displace to a position to mill the workpiece held by the rotary chuck 14. Therefore, conventional small lathe and miller assemblies cannot be used to mill lathed workpieces.

### SUMMARY OF THE INVENTION

This invention is related to an improved structure of a small lathe and miller assembly.

A primary object of the present invention is to provide an improved structure of a small lathe and miller assembly, in which a guide track means is provided between a lathe and a miller such that the miller may displace on the guide track means and the distance of the miller relative to a rotary chuck of the lathe is adjustable to allow a workpiece to be milled by the miller after being processed by the lathe.

Another object of the present invention is to provide an improved structure of a small lathe and miller assembly, in which a curved stop plate is provided to urge against a rotary shaft of the rotary chuck so as to set the angle of the workpiece held by the rotary chuck for lathing or milling purposes. A lock handle may be turned to retrieve the stop plate to allow the rotary chuck to freely rotate for further lathing or milling purposes.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is perspective exploded view of the prior art;

FIG. 2 is a schematic view of the prior art in which a cutter holder is mounted on the saddle seat of the lathe;

FIG. 3 is a schematic view of the prior art in which a workbench is mounted on the saddle seat of the lathe;

FIG. 4 is a perspective exploded view of the present invention;

FIG. 6 is a perspective exploded view of the present invention, in which an indexing element and a stop plate are assembled to a chuck seat of the lathe;

FIG. 7 is an assembled view of the present invention, in which an indexing element and a curved stop plate are assembled to the chuck seat of the lathe;

FIG. 8 is a schematic view illustrating the measuring of the angle of the rotary chuck by the stop plate urging against the rotary shaft of the rotary chuck; and

FIG. 9 is a schematic view of the present invention, in which the workbench is assembled to the saddle seat of the lathe.

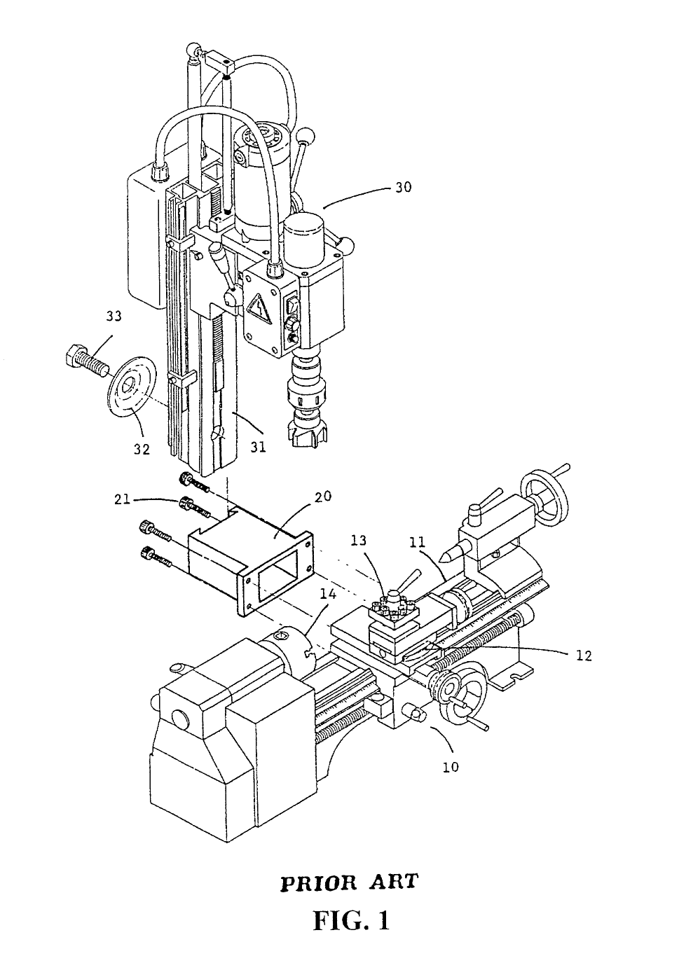

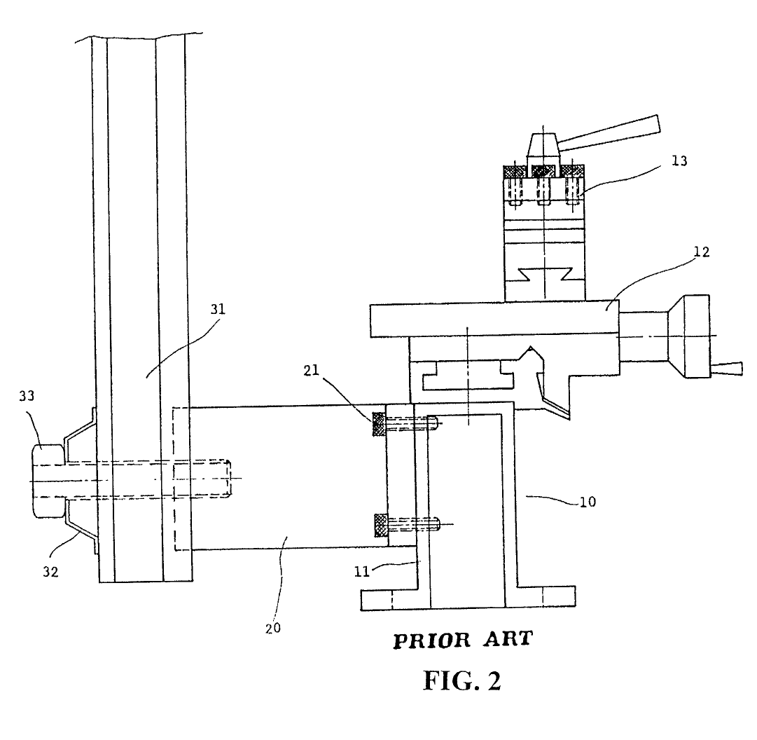

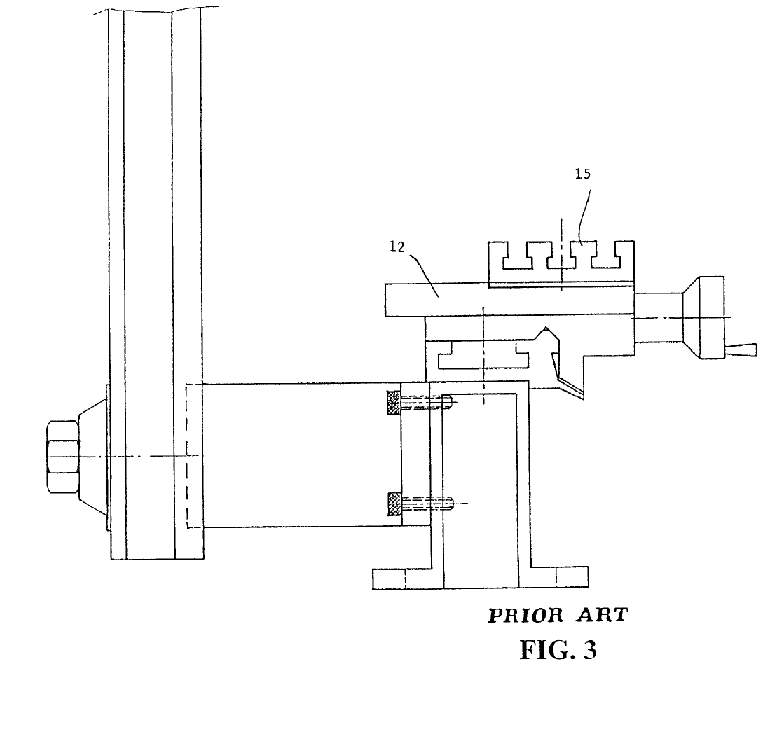

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

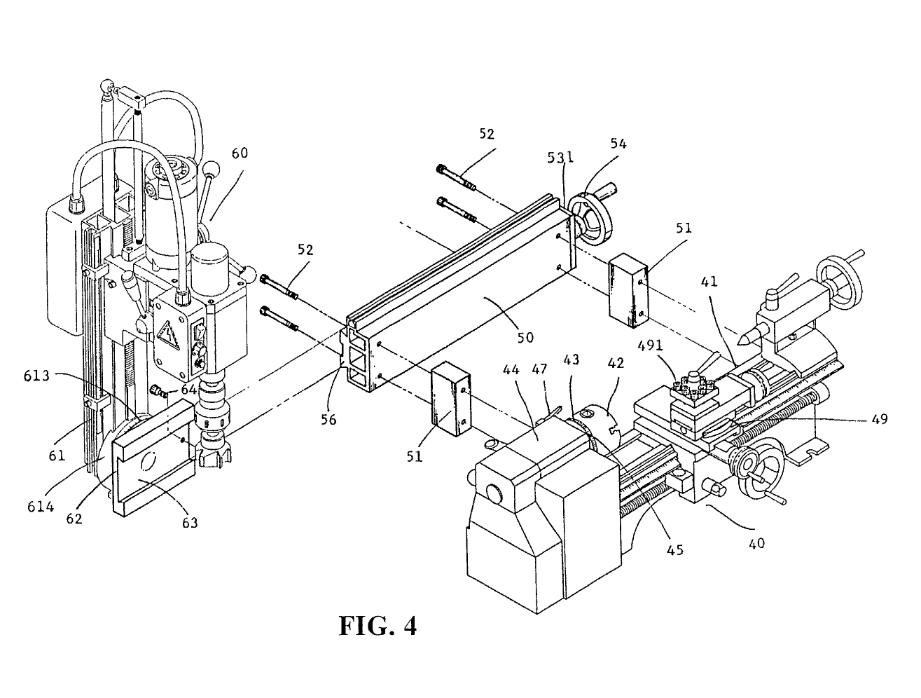

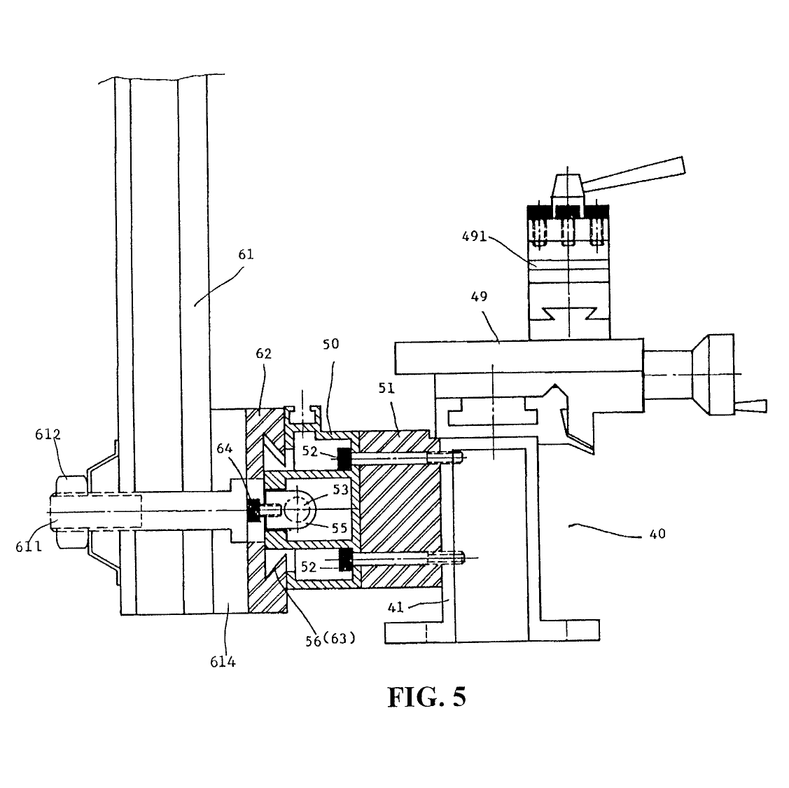

With reference to FIGS. 4 and 5, the present invention is directed to an improved structure of a small lathe and miller assembly, comprising a lathe 40, a guide track means 50, and a miller 60. The structure of the lathe 40 is substantially the same as conventional ones. The only difference is that the rear side of a lathe bed 41 of the lathe 40 is locked to the guide track means 50 y means of two mediating pillow blocks 51 and a plurality of bolts 52. The guide track means 50 includes a central chamber having an end plate 531 through which a guide screw rod 53 is passed, a hand wheel 54 connected to the guide screw rod 53, guide blocks 55 pivotally mounted on the guide screw rod 53, and two dovetail tenons 56 extending from the rear side of the guide track means 50 for engaging the miller 60. The structure of the miller 60 is also substantially the same as conventional ones. The only difference is that the miller 60 has a column 61 the bottom side of which is radially connected to a micrometer collar 614 with scale 613 thereon by means of a bolt 611 and 612. The micrometer collar 614 is further connected to a moving block 62. A front side of the moving block 62 is provided with dovetail slide grooves 63 for mating with the tenons 56 of the guide track means 50. The moving block 62 is screwably secured to the guide blocks 55 in the guide track means 50 by bolts 64.

When the hand wheel 54 is turned, the guide screw rod 53 is caused to turn therewith, bringing the guide blocks 55 to displace along the guide screw rod 53, furthering pulling the moving block 62 to displace along the guide track means 50. Hence, the distance of the miller 60 relative to a rotary chuck 42 of the lathe 40 may be adjustable so that, after a workpiece has been processed by the lathe 40, the miller 60 may continue to mill or drill holes in the workpiece.

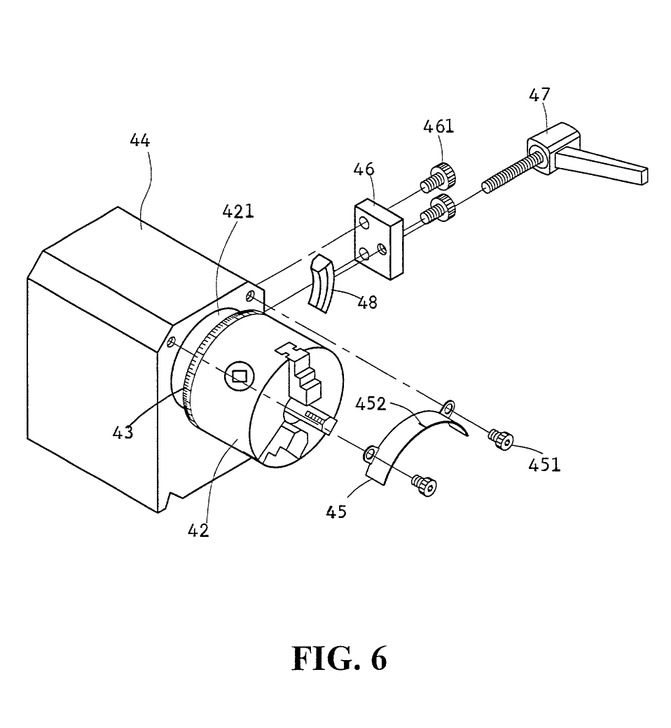

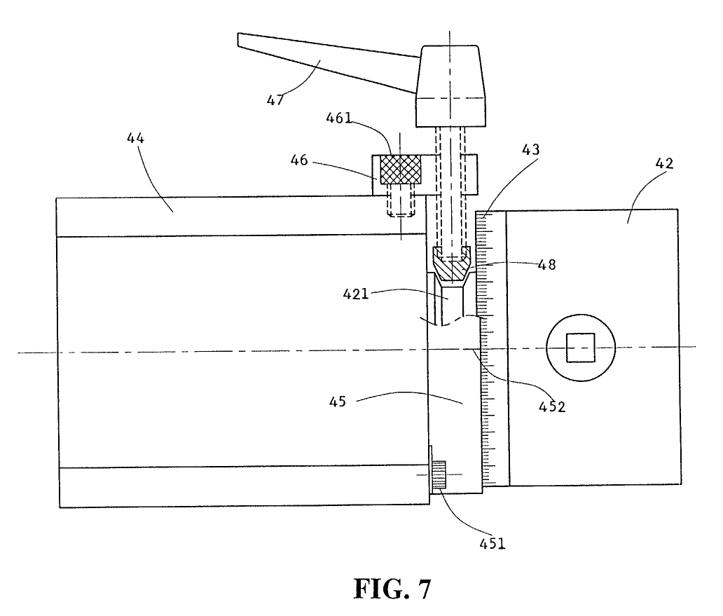

With reference to FIGS. 6 and 7, the outer periphery of the bottom end of the rotary chuck 42 of the lathe 40 is provided with a scale 43 indicating the angles of rotation. An indexing element 45 is locked to one side of the chuck seat 44. A curved protecting cover 45 with a scale 452 is fastened above the rotary chuck 42 on the chuck seat 44. In this way, the angle of the workpiece clamped by the rotary chuck 42 may be set. There is further provided a frame plate 46 on which a lock handle 47 is assembled so as to firmly secure a curved stop plate 48 on a rear side of the chuck seat 44.

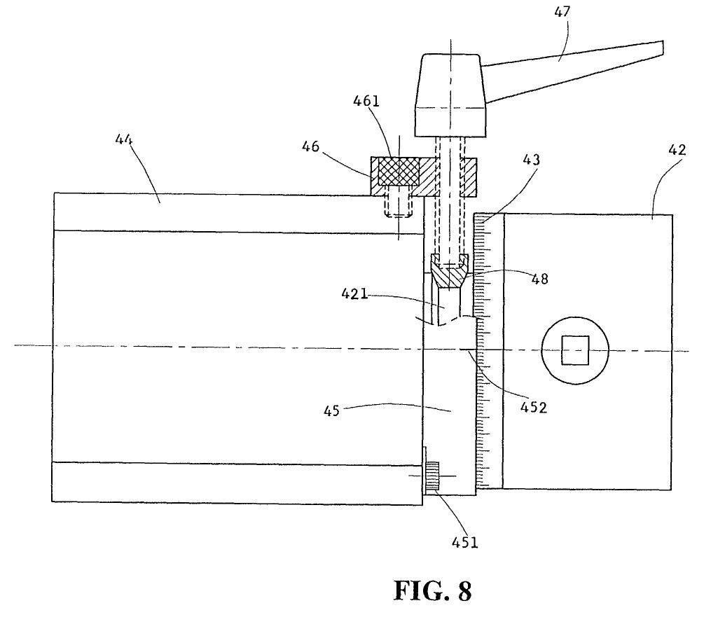

The frame plate 46 is locked to the rear side of the chuck seat 44 by means of bolts 461. Referring to FIG. 8, by driving the lock handle 47 inwardly, the stop plate 48 may be caused to urge forwardly against a rotary shaft 421 of the rotary chuck 42 to set the angle of the workpiece held by the rotary chuck 42, so that the workpiece may further be milled after being processed by the lathe 40.

With reference to FIG. 7, by releasing the lock handle 47 to retrieve the stop plate 48, the rotary chuck 42 may freely rotate to allow the workpiece to be processed by the lathe 40. It can therefore be appreciated that the present invention permits lathing and milling of a workpiece held by the rotary chuck 42 on the same structure.

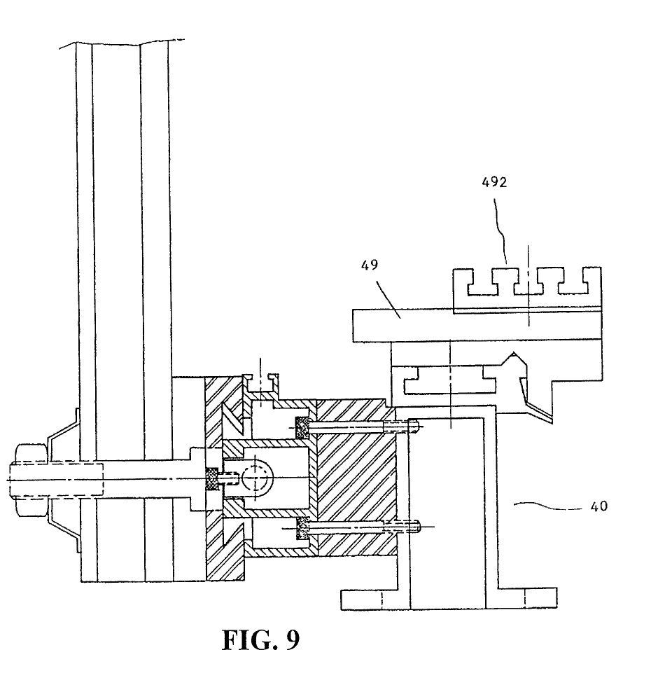

In addition, with reference to FIGS. 5 and 9, a cutter holder 491 on the saddle seat 49 of the lathe 40 may be dismantled and replaced by a workbench 492 for milling purposes, as is known in the art.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a small lathe and miller assembly, comprising lathe, a guide track means, and a miller, wherein:
said lathe has a lathe bed the rear side of which is locked to said guide track assembly by two mediating pillow blocks and a plurality of bolts;
said guide track means includes a central chamber having an end plate, a guide screw rod being passed through said central chamber and said end plate, a hand wheel connected to guide screw rod, guide blocks pivotally mounted on said guide screw rod, and dovetail tenons projecting from a rear side thereof for engaging said miller; and
said miller has a column the bottom side of which is radially connected to a micrometer collar with scale, said micrometer being in turned connected to a moving block, a front side of said moving block being provided with dovetail slide grooves for mating with said dovetail tenons of said guide track means, said moving block being screwably secured on said guide blocks in said guide track means by bolts; whereby said hand wheel may be turned to rotate said guide screw rod to further drive said guide blocks to displace along said guide screw rod and pull said moving block to displace along said guide track means, so that the distance of said miller relative to said rotary chuck of said lathe may be adjustable to allow a workpiece held by a rotary chuck mounted on a chuck seat of said lathe to be further milled or processed by said miller after being processed by said lathe.

2. The structure of a small lathe and miller assembly as defined in claim 1, wherein said rotary chuck of said lathe is provided with a scale on an outer periphery of a bottom end thereof, and an indexing element is locked at one side of said chuck seat of said rotary chuck for setting the angle of the workpiece held by said rotary chuck, and a curved protecting cover with a scale is fastened above said rotary chuck on said chuck seat.

3. The structure of a small lathe and miller assembly as defined in claim 1, wherein said chuck seat of said lathe is provided with a frame plate and a lock handle assembled to said frame plate to secure a curved stop plate to a rear side of said chuck seat, said frame plate being locked to the rear side of said chuck seat by bolts, whereby turning of said lock handle may cause said stop plate to urge forwardly against a rotary shaft of said rotary chuck to allow setting of angle of said rotary chuck, so that the workpiece may be further milled or processed by said miller after being processed by said lathe; and releasing of said lock handle may retrieve said stop plate to allow said rotary chuck to freely rotate for lathing purposes.
